(19) United States
(12) Patent Application Publication
(10) Pub. No.: US 2009/0092218 A1
(43) Pub. Date: Apr. 9, 2009

(54) Steam Dryer for Reactor Pressure Vessel

(75) Inventor: Andreas Lemm, Nurnberg (DE)

Correspondence Address: LERNER GREENBERG STEMER LLP, P O BOX 2480, HOLLYWOOD, FL, 33022-2480, US

(73) Assignee: AREVA NP GMBH, Erlangen (DE)

(21) Appl. No.: 12/246,909

(22) Filed: Oct. 7, 2008

(30) Foreign Application Priority Data
Oct. 9, 2007 (DE) 10 2007 048 478.1

(51) Int. Cl. G21C 15/16

(52) U.S. Cl. 376/371

(57) ABSTRACT

A steam dryer through which steam flows vertically, in particular for a nuclear reactor, contains a plurality of water tanks for removing water which has been separated from the steam. The water tanks are disposed below dryer elements through which the steam flows. The water tanks of the steam dryer have in each case in the flow direction a cross section which is favorable in terms of flow.

### CROSS-REFERENCE TO RELATED APPLICATION

This application claims the priority, under 35 U.S.C. §119, of German application DE 10 2007 048 478.1, filed Oct. 9, 2007; the prior application is herewith incorporated by reference in its entirety.

### BACKGROUND OF THE INVENTION

### Field of the Invention

The present invention relates to a steam dryer for a reactor pressure vessel, in particular a steam dryer, through which steam flows vertically, for a nuclear reactor, containing a plurality of water tanks for removing water which has been separated from the steam, which water tanks are arranged below dryer elements through which the steam flows.

The reactor pressure vessel of a modern light water reactor is a cylindrical steel vessel having a semi-spherical bottom and cover, which is connected to pipelines for a coolant. The upper cover can be lifted off in order to replace fuel assemblies and to carry out maintenance work. The cover is connected to the pressure vessel bottom part by numerous pre-tensioned threaded bolts and nuts. The reactor pressure vessel contains in particular a reactor core with urananium-containing fuel assemblies and the structures which are referred to as core components which fix the fuel assemblies at their intended location, such as the upper and lower core grid, the fuel assembly tanks, etc.

In a boiling water reactor, the reactor pressure vessel additionally contains a water separator or a steam dryer which separates off water droplets from the generated steam and retains them in the reactor pressure vessel. The water droplets contained in the steam could otherwise damage the turbine. Known water separators or steam dryers have water tanks which collect and discharge the water separated off from the steam. Since these water tanks are disposed upstream of the flow of steam to be dried, they exert a certain resistance counter to the flow and are in part responsible for the formation of eddies and flow disturbances. If more output is required from the steam dryer, this can result in difficulties.

### BRIEF SUMMARY OF THE INVENTION

It is accordingly an object of the invention to provide a a steam dryer for a reactor pressure vessel which overcomes the above-mentioned disadvantages of the prior art devices of this general type, which is suitable to a certain extent for output increases with increased steam throughput.

The object is achieved according to the invention by way of a novel steam dryer. The steam dryer through which steam flows vertically has a plurality of water tanks for removing water which has been separated from the steam, which water tanks are arranged below dryer elements through which the steam flows. The invention provides that the water tanks have in each case in the flow direction a cross section which is favorable in terms of flow. The water tanks can have, for example, in each case in the flow direction a rounded cross section. Alternatively, they can have a wedge-shaped, a drop-shaped, an oval or other cross section which is favorable in terms of flow. Avoiding a constriction in the flow can achieve an increased steam throughput with reduced spacings between water tanks. The same basic area can accommodate more dryer elements, and therefore an improved action of the dryer can be achieved. Additionally, avoiding edge eddies in the inlet flow can reduce the excitation of vibrations in the flow.

Another embodiment of the invention provides for the water tanks to have in each case largely the same spacings between one another with largely constant aperture cross sections for the steam to be dried. The water tanks preferably have in each case passages, which are favorable in terms of flow, to the dryer elements which are arranged downstream. Additionally, it can be advantageous if the water tanks are in each case connected to discharge lines which likewise have in each case one cross section which is favorable in terms of flow.

The inlets which are favorable in terms of flow can be produced without a significant increase in manufacturing complexity with respect to the cross sections and geometries used to date, with adequate cross sections for the discharged water also being retained.

Considerable output increases in steam dryers can be achieved with the aid of the embodiments according to the invention without this resulting in further problems such as overload effects. The embodiment, which is favorable in terms of flow, of the components which are situated traversly with respect to the flow prevents or reduces the formation of eddies. The steam-containing medium can flow past the place of disturbance without being impeded and without any noteworthy constriction, with the cross-sectional area of the water tanks being completely retained. The dryer packets can thus be pushed together more closely or have a greater structural height. In this manner it is possible overall to accommodate a larger dryer area in the reactor pressure vessel without this being accompanied by any other negative effects on the function.

Other features which are considered as characteristic for the invention are set forth in the appended claims.

Although the invention is illustrated and described herein as embodied in a steam dryer for a reactor pressure vessel, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a steam dryer in a reactor pressure vessel;

FIG. 2 is a schematic representation of an angular flow cross section of water tanks of the steam dryer according to the prior art;

FIG. 3 is a schematic representation of a round flow cross section of the water tanks of the steam dryer according to the invention;

FIG. 4 is a schematic representation of a sharply tapered flow cross section of the water tanks of the steam dryer according to the invention;

FIG. 5 is a schematic representation of a conically tapered flow cross section of the water tanks of the steam dryer according to the invention; and

FIG. 6 is a schematic representation of an ovally tapered flow cross section of the water tanks of the steam dryer according to the invention.

### DETAILED DESCRIPTION OF THE INVENTION

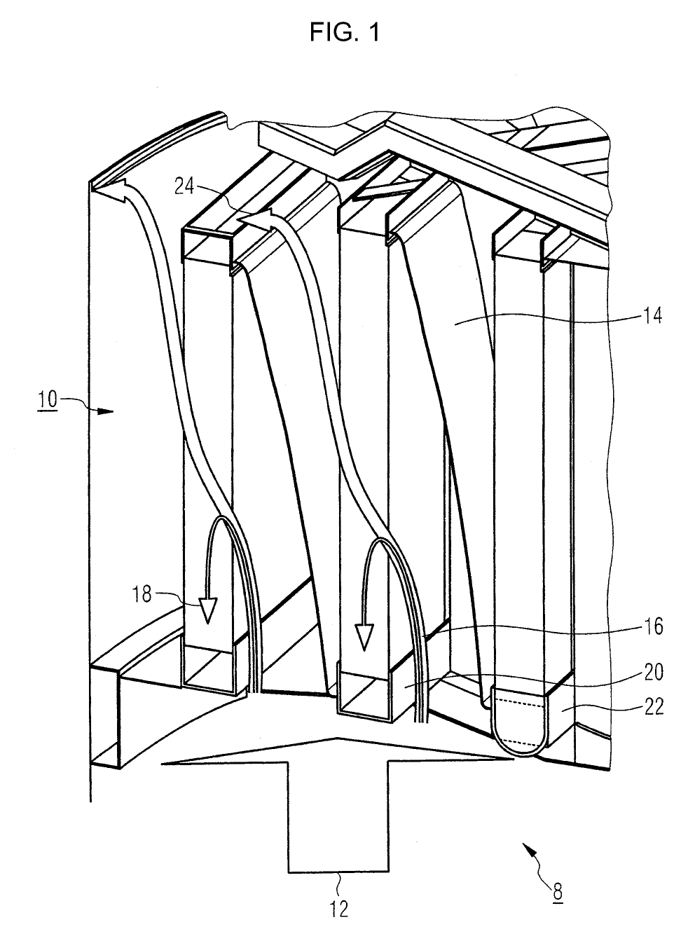

Referring now to the figures of the drawing in detail and first, particularly, to FIG. 1 thereof, there is shown a schematic representation of a configuration of a steam dryer 10 in a reactor pressure vessel 8. Moist steam forms an inflow 12 from non-illustrated separators to dryer packets 14 of the steam dryer 10. The steam 16 contained in this flow 12 is separated off to about 5% in the dryer packets 14 and guided as water 18 into water tanks 20 and 22, disposed beneath the dryer packets 14, from where it is removed. The reference numeral 20 here denotes water tanks of conventional geometry with edged cross sections which exert a relatively high resistance counter to the flow 12 and can contribute to the formation of eddies. The reference numeral 22, on the other hand, denotes water tanks of improved cross-sectional construction with are favorable in terms of flow and which will be explained in more detail in their alternative forms using the following figures. Finally, dry steam 24 flows upward from the dryer packets 14.

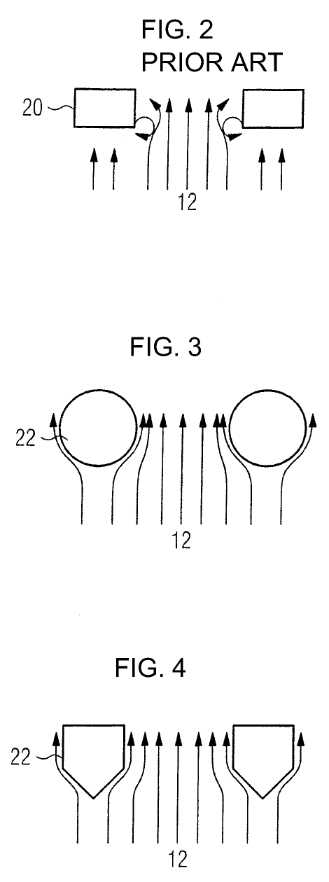

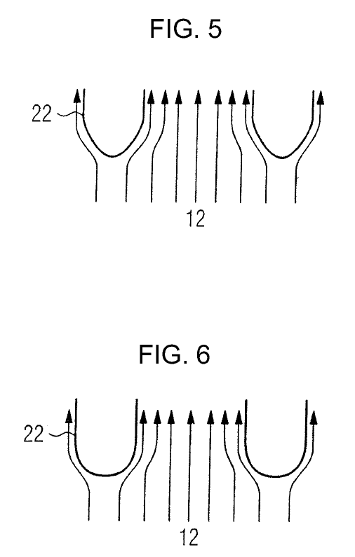

The schematic representation of FIG. 2 shows an angular flow cross section of the water tanks 20 of the steam dryer 10 according to the known prior art used hitherto, which makes it clear that the angular cross sections of the water tanks exert a clearly higher resistance counter to the inflowing moist steam 12 than the alternative cross-sectional designs according to the invention, as are shown in FIGS. 3 to 6. Here, FIG. 3 shows a schematic representation of a round flow cross section of the water tanks 22 of the steam dryer 10. FIG. 4 shows a schematic representation of a sharply tapered flow cross section of the water tanks 22 of the steam dryer 10. FIG. 5 shows a schematic representation of a conically tapered flow cross section of the water tanks 22 of the steam dryer 10. FIG. 6, finally, shows a schematic representation of an ovally tapered flow cross section of the water tanks 22 of the steam dryer 10.

1. A steam dryer through which steam flows vertically, the steam dryer comprising:
dryer elements; and
a plurality of water tanks for removing water separated from the steam, said water tanks disposed below said dryer elements through which the steam flows, said water tanks have in each case in a flow direction a cross section which is favorable in terms of flow.

2. The steam dryer according to claim 1, wherein said water tanks have in each case in the flow direction a rounded cross section.

3. The steam dryer according to claim 1, wherein said water tanks have in each case in the flow direction a wedge-shaped cross section.

4. The steam dryer according to claim 1, wherein said water tanks have in each case in the flow direction a drop-shaped cross section.

5. The steam dryer according to claim 1, wherein said water tanks have in each case in the flow direction one of an oval cross section and another cross section which is favorable in terms of flow.

6. The steam dryer according to claim 1, wherein said water tanks have in each case largely a same spacings between one another with largely constant aperture cross sections for the steam to be dried.

7. The steam dryer according to claim 1, wherein said water tanks have in each case passages formed therein, which are favorable in terms of flow, to said dryer elements which are disposed downstream.

8. The steam dryer according to claim 1, further comprising discharge lines and said water tanks are in each case connected to said discharge lines which have in each case a cross section which is favorable in terms of flow.

9. The steam dryer according to claim 1, wherein the steam dryer is configured for use in a nuclear reactor.
